(19) United States
(12) Patent Application Publication
(10) Pub. No.: US 2026/0038007 A1
(43) Pub. Date: Feb. 5, 2026

(54) REAL ESTATE APPRAISAL SYSTEM

(71) Applicant: Aivre, Inc., Birmingham, MI (US)

(72) Inventors: Jake Lew, Birmingham, MI (US); Jordan Lesson, West Bloomfield, CA (US)

(21) Appl. No.: 18/793,722

(22) Filed: Aug. 2, 2024

(51) Int. Cl. G06Q 30/02; G06Q 30/0201; G06Q 50/16

(52) U.S. Cl. CPC G06Q 30/0278; G06Q 30/0206; G06Q 50/16

(57) ABSTRACT

Systems and methods for quickly and efficiently creating real estate comparable property appraisal reports are disclosed. The methods and systems create a data set for comparable properties based on the address of a subject property. Analysis of the subject property against the data set for the comparable properties is performed. The methods and analysis include using third party generative AI tools to obtain, create and generate data and information used in the comparable property appraisal report. An appraisal value for the subject property is assigned based on the analysis. An appraisal report is generated that includes details about the subject property, the comparable properties, and the appraisal value.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to a software system that prepares real estate appraisals and sales price predictions, commonly referred to as real estate comparable sales (“comps”). More specifically, this disclosure relates to real estate comps generated in part by artificial intelligence (“AI”) processing.

### Description of the Related Art

Real estate comparable sales (“comps”) are used to validate the value of a property to be purchased, sold, foreclosed, financed or refinanced. Real estate comps are used to compare property values between a property to be valued in anticipation of sale or refinancing with recently sold properties that are comparable, sharing a similar size, location, and amenities. Real estate comps play a vital role in the real estate industry because they are used as a benchmark to assess the market value of a particular property. The appraisal process is crucial for sellers who want to determine a competitive price for their property, for buyers who want to ensure they are not overpaying, and for investors who want to learn if a property is a good investment.

The appraisal process is subjective. The selection of properties to use for the evaluation process and adjusting for differences between properties can vary based on the person doing the analysis. For example, two different real estate professionals might select different real estate comps or make adjustments based on their personal interpretation of the market and the specific properties involved. This can lead to different estimated values for the same property, which can cause confusion and potential disagreements when it comes to pricing a property for sale or determining a property's value for a potential investment.

Furthermore, the parties involved in buying, selling or financing a property may choose to elect an appraiser to conduct the evaluation. The appraiser may also have a subjective bias based on the person who hired them to conduct the evaluation of the property.

### THE DRAWINGS

FIG. 1 is a block diagram of an environment in which real estate appraisal systems and methods described herein are implemented.

FIG. 2 is a flow chart of actions taken according to the real estate appraisal systems and methods described herein.

FIG. 3 is a flow chart of the actions taken preparing a subject section according to the real estate appraisal systems and methods described herein.

FIG. 4 is a flow chart of the actions taken preparing a contract section according to the real estate appraisal systems and methods described herein.

FIG. 5 is a flow chart of the actions taken preparing a neighborhood section according to the real estate appraisal systems and methods described herein.

FIG. 6 is a flow chart of the actions taken preparing a site section according to the real estate appraisal systems and methods described herein.

FIG. 7 is a flow chart of the actions taken preparing an improvements section according to the real estate appraisal systems and methods described herein.

FIG. 8 is a flow chart of the actions taken preparing a sales comparison approach section according to the real estate appraisal systems and methods described herein.

FIG. 9 is a flow chart of the actions taken preparing a sale/transfer history section according to the real estate appraisal systems and methods described herein.

FIG. 10 is a flow chart of the actions taken preparing an income section according to the real estate appraisal systems and methods described herein.

FIG. 11 is a flow chart of the actions taken calculating a cost approach according to the real estate appraisal systems and methods described herein.

FIG. 12 is a flow chart of the actions taken preparing a market conditions section according to the real estate appraisal systems and methods described herein.

FIG. 13 is a flow chart of the actions taken for preparing a text addendum section according to the real estate appraisal systems and methods described herein.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously described element having a reference designator with the same least significant digits.

### DETAILED DESCRIPTION

Real estate appraisal methods and systems having automated features and artificial intelligence features are described herein. By using modern computing techniques and artificial intelligence tools, a more timely, quickly provided real estate appraisal is provided while removing human bias and subjective human errors. The resulting appraisal is more accurate while being provided more quickly than traditional methods.

### The System

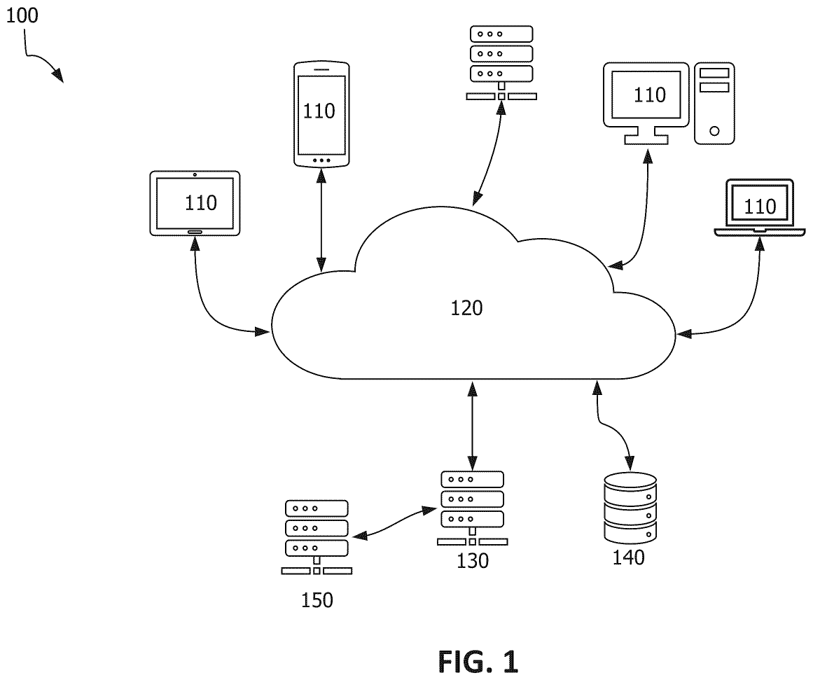

Referring now to FIG. 1, there is shown a block diagram of an environment 100 in which a real estate appraisal system and methods described herein are implemented. The methods described herein may be implemented on one or more server computers referred to as the comp appraisal system 130. The comp appraisal system 130 includes software running on one or more server computers for providing the functionality and features described herein. The hardware and software and their functions may be distributed such that some are performed by one server computer and other by other server computers. The server or servers that comprise the comp appraisal system 130 includes one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the comp appraisal system 130 may include various specialized units, circuits, software and interfaces for providing the functionality and features described herein. The methods, functionality and features are embodied in whole or in part in software which operates on the comp appraisal system 130 and may be in the form of an application program, firmware, an applet (e.g., a Java applet), a browser plug-in, a COM object, a dynamic linked library (DLL), a script, one or more subroutines, or an operating system component or service. The hardware and software and their functions may be distributed such that some components are performed by multiple servers that comprise the comp appraisal system 130 and others by other computing devices co-located with the comp appraisal system and/or at other locations within the same building or campus, and/or at other disparate geographic locations.

The software in comp appraisal system 130 communicates with other servers that have multiple listing service (“MLS”) databases 140 through a network 120 (described below). The MLS databases 140 include various property listings that are publicly accessible through an application programming interface (“API”). The comp appraisal system 130 may also store previously generated real estate comps in a comps database for use in real estate comp analyses.

The comp databases may be implemented using structured query language more commonly known as SQL or MySQL as well as other database software. The comp appraisal system 130 may access third party artificial intelligence (“AI”) systems 150 to obtain evaluation data specific to the property to be appraised (hereinafter referred to as the “subject property”).

Although the comp appraisal system 130 is shown implemented in a server computer, the processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, and Apple MacOS operating systems.

The techniques may be implemented in software and stored on machine readable storage media in a storage device included with or otherwise coupled or attached to the comp appraisal system 130. That is, the software may be stored on electronic, machine-readable media. These storage media include, for example, magnetic media such as hard disks, optical media such as compact disks (CD-ROM and CD-RW) and digital versatile disks (DVD and DVD+RW); silicon media such as solid-state drives (SSDs) and flash memory cards; and other magnetic, optical or silicon storage media. As used herein, a storage device is a device that allows for reading from and/or writing to a storage medium. Storage devices include hard disk drives, DVD drives, flash memory devices, and other silicon, optical or other types of physical media.

The comp appraisal system 130 may be implemented as a platform as a service (“PaaS”) or a software as a service (“SaaS”). In this way, the comp appraisal system 130 communicates with users on computing devices 110 through a network 120. Users of the computing devices 110 communicate with comp appraisal system 130 through the network 120. The network 120 comprises one or more public and/or private data networks, and other networks and sub-networks, and may include or be the Internet. The network 120 may also include or access cellular telephone and land line telephone networks and may be wired and wireless or a combination. The network 120 includes additional devices (not shown), such as routers, switches, firewalls, multiplexors, and other networking equipment that enable and enhance network communications. Additional specialized servers such as application servers, database servers, and others may be coupled with or included with the comp appraisal system 130 either directly connected and/or over the network 120.

### Description of Processes

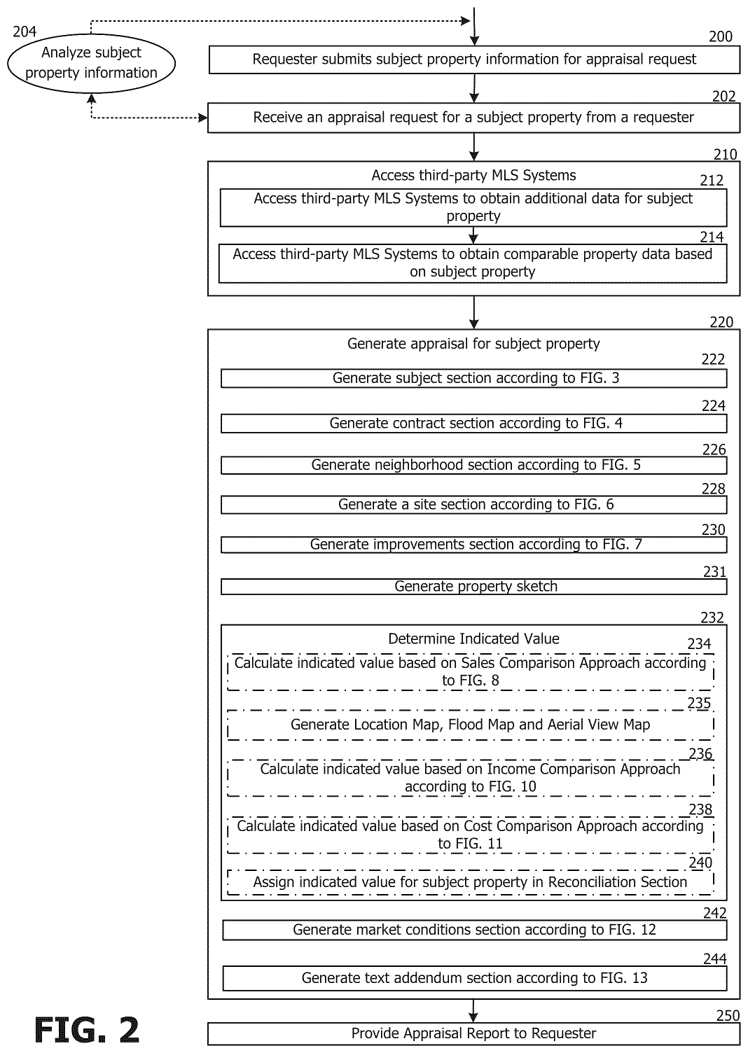

The systems and methods described herein provide for an appraisal of a subject property necessary or helpful during purchase, sale, foreclosure, financing and servicing transactions of the subject property. Referring now to FIG. 2, a flow chart of actions taken to generate an appraisal is presented. To start the method, a requester navigates to a web page or online portal where a graphical user interface is presented to the requester. The graphical user interface may prompt the requester to create an account. The requester submits an appraisal request to the comp appraisal system, as shown in block 200. The requester may be a seller, buyer, real estate agent, appraiser, bank or other party interested in or involved in the sale or valuation of a subject property. The requester submits the appraisal request through a graphical user interface (not shown) in which the requester is prompted or otherwise instructed to specify information about the subject property.

The subject property information included in the appraisal request may include but is not limited to the address, city, state, zip code, images (that is photos) of the subject property, a purchase agreement, engagement letter, or order sheet for the subject property, property size, number of bedrooms, number of bathrooms, whether the subject property is single family home a condominium, a manufactured home, a modular home or a multi-family home, available utilities, appliances in the home, heating/cooling availability, and/or one or more comparable property addresses of likely comparable properties. A comparable property is a property that is similarly situated with the subject property. Comparable properties share common characteristics with the subject property, such as, for example, being in the same neighborhood, having the same school district or same school, having the same number of floors, having a similar size, having a similar number of bedrooms, having a similar number of bathrooms, etc. It is to be understood that the requester may be prompted with one or more screens to input the subject property information. For example, a first screen may prompt the requester to input the subject property address, wherein a subsequent screen may prompt the requester to upload photographs of the subject property.

After the requester submits the appraisal request to the comp appraisal system via the network, the comp appraisal system receives the appraisal request, as shown in block 202, and then analyzes the subject property information provided by the requester, as shown in block 204. In one embodiment, the appraisal request includes the address of the subject property and nothing more. In this embodiment, the action of the comp appraisal system analyzing the subject property information includes validating the address. In another embodiment, the comp appraisal system analyzing the subject property information provided by the user includes validating the information provided and assessing information that is missing or not received. For example, in this embodiment, and, depending on the embodiment, if the subject property address, number of bedrooms, square footage, or other characteristic required or preferred by the system is missing, the comp appraisal system may alert the requester to revise the information provided. In this situation, the flow of actions continues at block 200. Alternatively or additionally, the comp appraisal system may automatically correct the requester supplied information using MLS information along with the actions in block 210.

After analyzing the subject property information, the comp appraisal system gathers additional for the subject property and comparable properties, using third party MLS data, as shown in block 210. The comp appraisal system may use third-party MLS systems such as, for example, but not limited to, Propmix available from PropMix.io LLC. of Bayside, New York, RESTB.AI of Barcelona, Spain, and others. The comp appraisal system communicates with such third-party MLS systems via API connections over a network (such as network 120 described above regarding FIG. 1). The comp appraisal system requests from third-party MLS systems additional information about the subject property, as shown in block 212. The additional information includes but is not limited to address, city, state, zip code, subject property images, a purchase agreement, engagement letter, or order sheet for the subject property, property size, number of bedrooms, number of bathrooms, whether the subject property is a single family home, a manufactured home, a modular home, a condominium or multi-family home, available utilities, appliances in the home, heating/cooling availability, and/or one or more addresses of comparable properties. The comp appraisal system then combines the subject property information received from the requester with the subject property information received from the third-party MLS tool, referred to herein collectively as the “subject property data”.

The comp appraisal system then requests from third-party MLS systems one or more comparable property listings using the subject property address as a criterion, as shown in block 214. The criterion used for the third-party MLS systems may include but is not limited to: proximity radius, number of bedrooms, number of bathrooms, sale price, property square footage, flood data and/or other property details sufficient to obtain comparable properties with the subject property. For example, the comp appraisal system requests from the MLS systems comparable properties within a five-mile radius having the same number of bedrooms and bathrooms as the subject property. It is to be understood that the search criteria may be broadened or narrowed depending on the size of the search results, the number of properties provided in the results. The comp appraisal system may request multiple searches from the MLS systems to receive a sufficient number of comparable properties within a given criterion. For example, the comp appraisal system may request from the MLS systems comparable properties within a five-mile radius, and then may make subsequent requests expanding the radius if previous requests yield a small number of properties, such as two, three or fewer comparable properties, depending on the implementation. The comparable properties data received from third-party MLS systems includes property information and characteristics including but not limited to address, city, state, zip code, subject property images, a purchase agreement, engagement letter, or order sheet for the subject property, property size, number of bedrooms, number of bathrooms, whether the subject property is single family home a condominium or multi-family home, available utilities, appliances in the home, heating/cooling availability. The comparable properties data is used to create a comparable property data set. The comp appraisal system then combines the comparable property information received from the requester, if provided by the requester, with the comparable property information received from the third-party MLS systems, referred to herein collectively as the “comparable properties data” or the “comparable property data set”.

The comp appraisal system then generates the appraisal of the subject property as shown in block 220. The appraisal generation may be a multi-part sequence of grouped actions that generate a respective section of the appraisal. The appraisal typically adheres to commercial real estate appraisal forms, such as, but not limited to, Fannie Mae Uniform Residential Appraisal Report “Form 1004,” Fannie Mae Individual Condominium Unit Appraisal Report “Form 1073,” and/or Fannie Mae Market Condition Addendum “Form 1004MC.” The appraisal may additionally and/or alternatively be in the form of a custom report. This custom report is not Fannie Mae compliant and, instead, is designed for people unfamiliar with the real estate industry and the appraisal industry. The custom report presents the same or similar information as in a Fannie Mae compliant appraisal but arranges and displays the information in an easy to understand fashion so that persons inexperienced in the real estate and appraisal area can readily understand the valuation of a home and the appraisal process. The respective sections of the appraisal and custom report include some or all of: a subject section, a contract section, a neighborhood section, a site section, an improvements section, a sales comparison approach section, an income approach section, a cost approach section, a reconciliation section, a market conditions section, a text addendum section, a photo addendum section, and a site value opinion section. Typically, all or most of the sections are included in the appraisal or custom report. In some situations, the income approach section and/or cost approach section are omitted depending on the particular property. Based on the kind of property, if the appraisal includes a 1007 Rent Schedule and 216 Income Operating Statement, the appraisal will include an income approach section which includes an income approach value. The inclusion of and content of the cost approach section may vary based on requirements set by lenders.

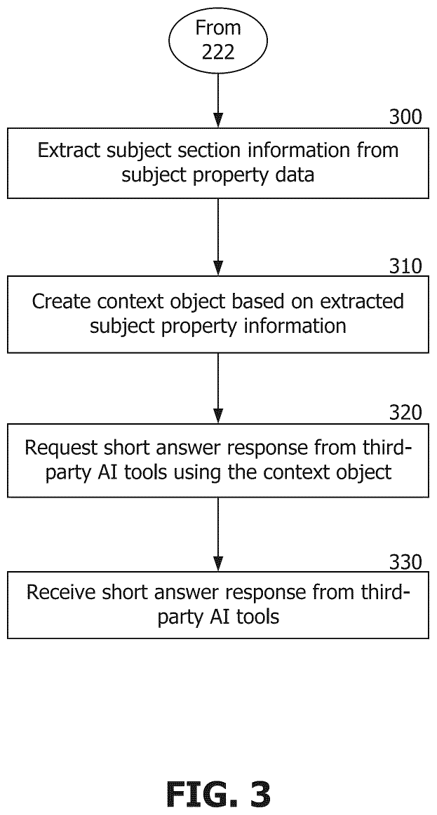

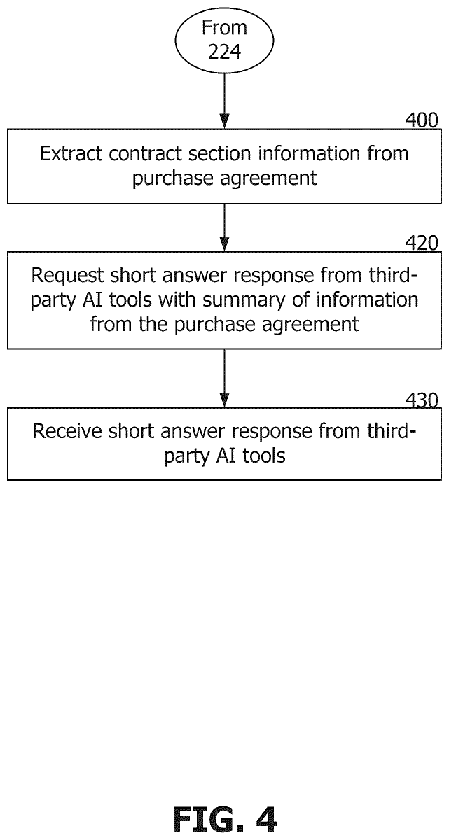

The comp appraisal system begins appraisal generation at block 222 of FIG. 2 with generating the subject section, the details of which are provided in FIG. 3. Referring now to FIG. 3, the comp appraisal system begins generating the subject section by extracting subject section information from the subject property data, as shown in block 300, wherein the subject property data includes but is not limited to the subject property address (including: city, state, zip code), borrower, owner of public record, county, legal description, assessor's parcel number, neighborhood name, map reference, tax year, census tract, whether the occupant of the subject property is the owner, whether there is a tenant or is vacant, special assessment values, planned unit development or homeowners association costs and whether the costs are monthly or yearly, whether the subject property is held in fee simple, leasehold or other, assignment type including whether the subject property was a purchase transaction, finance transaction, refinance transaction, foreclosure, debt servicing or other, the lender and lender address, whether the subject property is offered for sale or has been offered for sale in the prior twelve months of the appraisal period, the report data sources used, offering prices and dates. The comp appraisal system then uses the extracted data to create a context object, as shown in block 310. The context object is defined as a listing of details in a name/value pair that represent information about the request being sent to a third-party application programming interface. The comp appraisal system then uses the context object to query or otherwise communicate with a third-party generative AI tool to request a short answer response, as shown in block 320, via third-party AI tool API. A short answer response is defined as a sentence or brief paragraph generated by the third-party AI tool based on the context object provided to the third-party AI tool by the comp appraisal system. The comp appraisal system then receives the short answer responses from the third-party AI tools, and it is the content of these responses which are used to prepare the subject section of the appraisal, as shown in block 330. For example, the third-party AI tool may be OpenAI's CHATGPT, wherein the comp appraisal system provides the AI tool the subject property data and is prompted with subject section related prompts such as the legal description or report data sources used. If the initial information input is provided with an engagement letter, the comp appraisal system may also utilize third-party AI tools to obtain, learn, and extrapolate pertinent details about the subject property to be included in the subject section. For example, if the comp appraisal system is provided with the engagement letter by the requester, the engagement letter may be converted to an image by the comp appraisal system and provided to an AI vision tool or image evaluation tool, such as, for example, the OpenAI GPT4 Vision AI tool, to request information such as lender name and lender address to be culled from the engagement letter to be used and included in the subject section. The short answer responses received from the third-party generative AI tool conform to commercially available appraisal forms such as but not limited to: “Form 1004,” “Form 1073,” and/or “Form 1004MC.” Referring again to FIG. 2, the comp appraisal system then generates the contract section of the appraisal, as shown in block 224, the details of which are provided in FIG. 4.

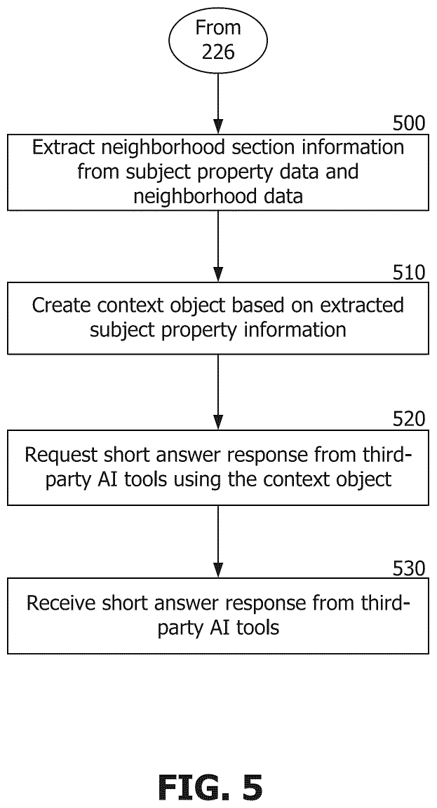

Referring now to FIG. 4, the comp appraisal system begins generating the contract section by extracting pertinent information for the subject property from the purchase agreement, which is the subject property's contract for sale, if applicable, as shown in block 400. The data from the subject property's contract for sale includes, but is not limited to, whether the contract for sale was or was not reviewed, contract price, date of the contract, if the property seller is the owner of public record, data sources used, and whether any financial assistance such as loan charges, sale concessions, gift or downpayment assistance was used to pay any party involved with the sale of the subject property on behalf of the borrower. The comp appraisal system then communicates with a third-party generative AI tool, typically via an API, and requests a short answer response, requesting a summary of information from the purchase agreement which the comp appraisal system provides with the request, as shown in block 420. The comp appraisal system then receives a short answer response from the third-party AI tool API, as shown in block 430, and uses the response to prepare the contract section of the appraisal. For example, the third- party generative AI tool may be OpenAI's CHATGPT and the comp appraisal system provides the AI tool a prompt (or request) to return an explanation of the contract for sale for the subject property. If the subject property data includes the purchase agreement, the comp appraisal system may also use third-party AI tools to extrapolate or derive pertinent details regarding the subject property. For example, if the comp appraisal system is provided with the purchase agreement, the comp appraisal system may convert the purchase agreement to an image which the comp appraisal system then communicates OpenAI GPT4 Vision to prompt the AI tool to return information such as the buyer and seller names, and other pertinent data, from the purchase agreement image. The short answer responses received from the third-party generative AI tool conform to commercially available appraisal forms such as, but not limited to, “Form 1004,” “Form 1073,” and/or “Form 1004MC.” Referring again to FIG. 2, the comp appraisal system then generates the neighborhood section of the appraisal, as shown in block 226, the details of which are provided in FIG. 5.

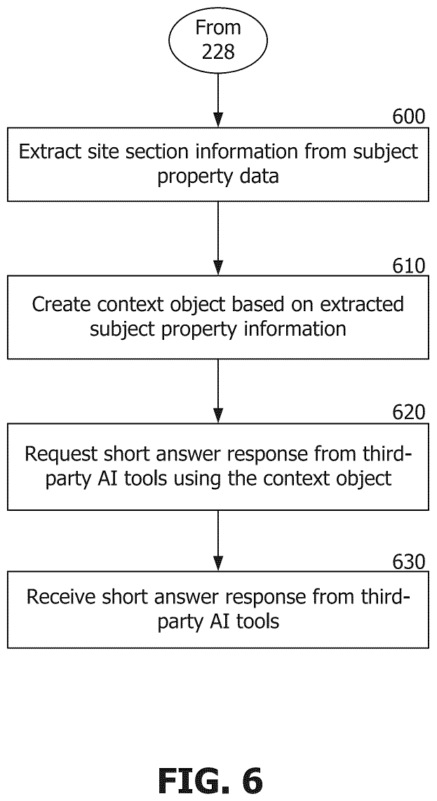

Referring now to FIG. 5, the comp appraisal system begins generating the neighborhood section by extracting information from the subject property data and neighborhood data, as shown in block 500. This extracting includes obtaining information from the subject property data, defined above. This extracting includes obtaining information about the neighborhood from neighborhood data (and characteristics), which includes, but is not limited to, whether the location is urban, suburban or rural; whether the percentage of the available land in the neighborhood that has been improved, referred to as the “build up”, such as whether the “build up” is over 75%, between 25-75%, or under 25% (other scales or percentages may be used); whether growth in the neighborhood is rapid, stable or slow; one-unit housing trends including price and age; present land use for one-unit, two to four unit, multi-family, commercial or other properties; neighborhood boundaries, neighborhood description and neighborhood market conditions. The comp appraisal system then uses the extracted data to create a context object, as shown in block 510. The comp appraisal system then sends a request for a short answer response to a third-party AI tool by communicating via an API of a third-party generative AI tool, as shown in block 520. The comp appraisal system then receives short answer responses, as shown in block 530. The comp appraisal system uses the responsive information received from the third-party AI tool to create the neighborhood section of the appraisal. For example, the third-party AI tool may be OpenAI's CHATGPT wherein the comp appraisal system provides a prompt (or request) to the AI tool to return a description of the market conditions relating to general vicinity of the subject property. The context object is used to make this request. The short answer responses received from the third-party generative AI tool conform to commercially available appraisal forms such as but not limited to: “Form 1004,” “Form 1073,” and/or “Form 1004MC.” Referring again to FIG. 2, the comp appraisal system then generates the site section of the appraisal, as shown in block 228, the details of which are provided in FIG. 6.

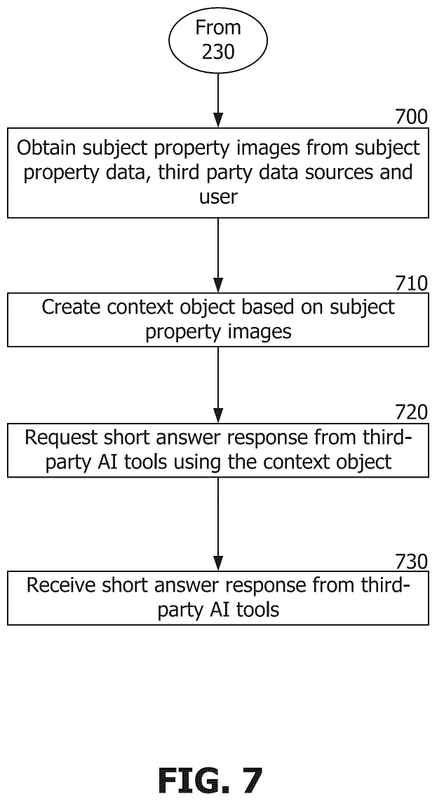

Referring now to FIG. 6, the comp appraisal system begins generating the site section by extracting information from the subject property data, as shown in block 600, including but not limited to dimensions, area, shape, highest and best use of the subject property, zoning classification, description and compliance, utility availability such as electricity, water or gas and whether it is public or other, if the subject property is in a FEMA flood zone, or if there are any adverse site conditions or external factors such as easements, encroachments, environmental conditions or land uses. The comp appraisal system then uses the extracted data to create a context object, as shown in block 610. The comp appraisal system then uses the context object to communicate a request for a short answer response to a third-party generative AI tool, as shown in block 620. This is typically done via an API of the third-party AI tool. The comp appraisal system then receives short answer responses, as shown in block 630. The comp appraisal system then uses the short answer responses to prepare the site section of the appraisal. For example, the third-party AI tool may be OpenAI's CHATGPT wherein the comp appraisal system provides the AI tool a prompt to return a description of adverse site conditions relating to the subject property. The short answer responses received from the third-party generative AI tool conform to commercially available appraisal forms such as but not limited to “Form 1004,” “Form 1073,” and/or “Form 1004MC.” Referring again to FIG. 2, the comp appraisal system then generates the improvements section of the appraisal, as shown in block 230, the details of which are provided in FIG. 7.

Referring now to FIG. 7, the improvements section, this section contains information about improvements to the subject property, the condition of the subject property, and deferred maintenance needed on the subject property. The improvements section includes information about features of the subject property as well as deferred maintenance information and repairs and other actions needed to maintain the subject property some of, but not limited to, number and condition of units/rooms; number of stories; the foundation type such as a concrete slab, inclusive of a crawl space, full or partial basement; the year the subject property was built; attic kind and condition, such as whether the attic is drop stair, floor or finished; a description of the exterior describing foundation walls, exterior walls, window types (including number kind, and condition), gutters and downspouts (including number, size and condition), screens (including number, size and condition), roof material and condition, amenities such as fireplaces, patio/deck (including material, size and condition), pool (including size and condition), or fence (including type, height, size and condition), a description of the interior such as the floors, walls, trim/finish, bath (including type or kind and condition); car storage including number of garages, car ports and car spots, driveway or driveways, driveway surface (including number, type or kind and condition); whether the subject property has appliances such as a refrigerator, dishwasher, microwave (including number, type or kind and condition); whether there is heating and cooling and the number and size of the heating and cooling units/systems; as well as descriptions of the condition of the property and how it relates to the neighborhood. The comp appraisal system begins to generate the improvements section by obtaining or retrieving images of the subject property from the subject property data, third party data sources and the user as shown in block 700. The comp appraisal system then creates a context object including the subject property images, as shown in block 710. The comp appraisal system then uses the context object to communicate a request for a short answer response to a third-party image recognition AI tool, as shown in block 720. This is typically done via an API made available by the third-party image recognition AI tool. The comp appraisal system utilizes the third-party image recognition AI tool (such as, for example, Restb.ai) to detect and label property features and characteristics, such as, but not limited to appliances, materials, room types, and other of the information listed in this paragraph. The third-party image recognition AI tools may also provide condition and quality of construction for the subject property and relating items. The comp appraisal system then receives short answer responses relating to the improvements needed for the subject property from the third-party AI tool, as shown in block 730. The comp appraisal system then uses the short answer responses to prepare the improvements section of the appraisal. The short answer response may include labeled images of the subject property based on the context object request. For example, the third-party AI tool may be OpenAI's ChatGPT4 Vision wherein the comp appraisal system provides a prompt (or request) to the AI tool to return a description of the condition of the subject property along with labeled versions of the subject property images designating areas of concern, both or either good and bad. The short answer responses received from the third-party generative AI tool conform to or are used to prepare improvement information that conforms to commercially available appraisal forms such as but not limited to: “Form 1004,” “Form 1073,” and/or “Form 1004MC.”

The comp appraisal system then evaluates, determines and categorizes repairs, modifications, and problems with the subject property and may categorize them as physical depreciation, functional depreciation or external depreciation (collectively referred to as “depreciation categories”). The term “improvements needed” is defined as items that need to be added, replaced or refurbished, such as but not limited to, utilities, appliances, paint, roofing, landscaping, foundation, driveway, drainage, gutters, windows, etc. The physical depreciation refers to the loss in value of the subject property based on physical deterioration. The functional depreciation refers to the loss in value of the subject property due to lack of utility or desirability. The external depreciation refers to the loss in value of the subject property due to forces outside the physical structure including locational or economic obsolescence. After categorizing each of the improvements needed, the comp appraisal system determines the loss in value for each of the depreciation categories using standardized pricing or a third-party estimator tools. The comp appraisal system may use standardized pricing for the value loss for each of the depreciation categories set internally by users running the comp appraisal system on their servers. Standardized pricing is derived from the cost of material used to construct the house, such as brick, wood, stone, aluminum, etc. and the amount of square footage. A cost per square footage is based on the materials used on the home/property. The comp appraisal system may also utilize third-party estimator tools to determine the value loss for each of the depreciation categories. For example, if the comp appraisal system identifies that the subject property needs a new roof, the comp appraisal system will then assign the need for a new roof as a physical depreciation and will then utilize internal standardized pricing or request pricing for a new roof through the API of the third-party estimator tools to determine the value loss of a new roof. The comp appraisal system similarly determines the depreciation cost for each of the repairs or improvements needed. Using the same new roof example, the comp appraisal system will also determine the cost for replacing the roof using standardized values either set internally by users running the comp appraisal system on their servers or using third-party estimator tools. The comp appraisal system then determines the as-is value of the improvements needed. The as-is value refers to existing improvements that require maintenance. For example, if the subject property requires landscaping work, the comp appraisal system will determine the standardized value for landscaping the subject property. The as-is value is also determined using standardized values set internally by users running the comp appraisal system on their servers or using third-party estimator tools.

Referring again to FIG. 2, the comp appraisal system generates a property sketch, as shown in block 231. The property sketch is a drawing that shows the exterior and interior dimensions of the subject property. The property sketch displays the measurements of the outer structure of the subject property and the measurements of the floor plan of the subject property, namely all rooms included in the subject property. The property sketch includes determining the square footage and gross living area measurements for the subject property. These measurements are later used in the sales comparison approach described below. The property sketch may also include a porch, patio, deck, balcony, barn, inground pools, landscape features, treehouses, ponds, streams, and the like appurtenant to or included in the subject property. The property sketch may be initiated by the appraiser using third party drawing tools incorporated in or accessible to the comp appraisal system. In one embodiment, the comp appraisal system receives room and structure measurements from the appraiser or user of the system and generates the square footage/gross living area measurements as well as the sketch based on those measurements. In another embodiment, the comp appraisal system refers to the room and structure measurements earlier obtained from the MLS or other third party real property data service when obtaining additional information pursuant to block 212 of FIG. 2. described above, and generates the square footage/gross living area measurements as well as the sketch based on those measurements. In yet another embodiment, the comp appraisal system obtains room and structure measurements from the MLS or other third party real property data service via a website or database using an API or other data communication technique, and generates the square footage/gross living area measurements as well as the sketch based on those measurements.

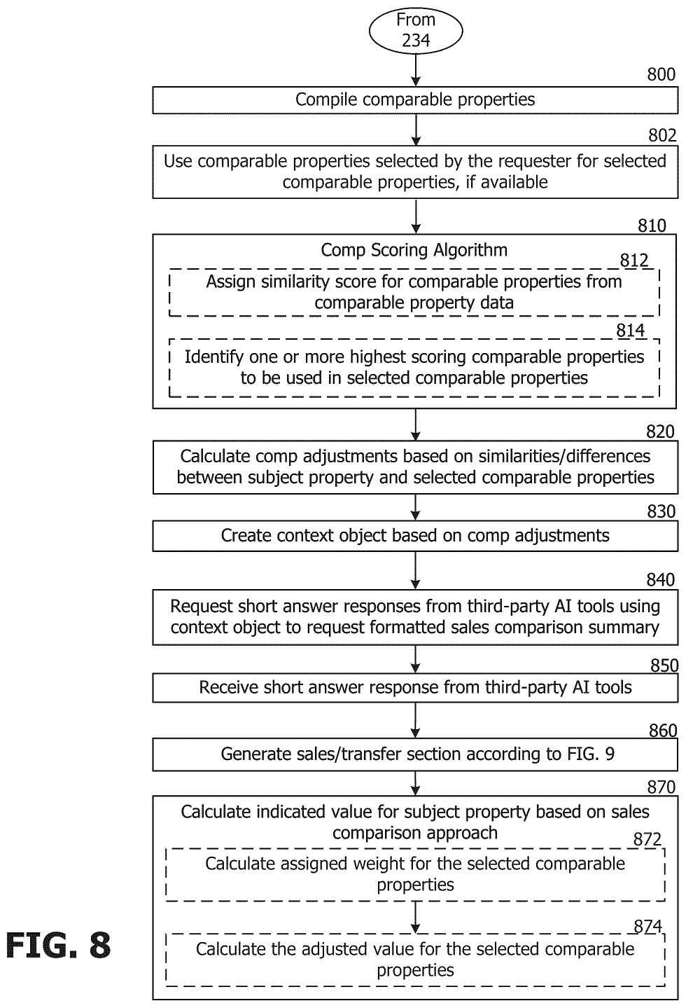

After the sketch is created, the comp appraisal system determines the indicated value of the subject property to be included in the appraisal, as shown in block 232. The indicated value may be determined by three approaches, an indicated value based: on the sales comparison approach, the income approach and the cost approach. The indicated value based on the sale comparison approach is a commercial standard for indicated value whereas the indicated value based on cost and income are optional, and are specified by the requester. The comp appraisal system may calculate the indicated value based on all three approaches to provide the requester, whereupon the requester may choose to deselect which calculation they choose to proceed with that will appear for the appraisal. The comp appraisal system begins by calculating the indicated value based on the sales comparison approach as shown in block 234, for which details are provided in FIG. 8.

Referring now to FIG. 8, the comp appraisal system proceeds with the sales comparison approach. The comp appraisal system may compile comparable properties per block 800 and/or use comparable properties selected or designated by the user per block 802.

To compile the comparable properties per block 800, the comp appraisal system conducts a comparative analysis between the subject property and three or more comparable properties. By using comparative analysis via computer, a more timely, quickly provided result is achieved while removing human bias and subjective human errors. Using a comparative analysis approach, the comp appraisal system computes a value for the subject property using details for each of the comparable properties and the subject property, such as, but not limited to the number of comparable properties currently offered for sale in the subject property market area within in a designated price range, the number of comparable sales in the subject property market area within the past twelve months within in a designated sale price range, addresses for the subject property and comparable properties, proximity to the subject property sale price, value adjustments such as sale or financing concessions, date of sale/time along with respective descriptions and adjustments made for each of the comparable and subject property, location, whether the comparable properties are held in leasehold/fee simple, design, quality of construction, actual age, condition, room count, bathroom count, square footage, whether there is a basement and finished rooms below grade, whether there are functional utilities, heating/cooling system size and type, energy efficient items, garage/carport, porch/patio/deck, the net and gross adjustment and adjusted sale price of comparable properties, whether research for the sale or transfer history of the subject property and comparable sales was conducted and related explanation (this may be, for example 12, 18 24, 36, 48, etc. month transfer history and comparable sales from prior 12, 18, 24, etc. months), data source(s) such as the third-party MLS systems, analysis of prior sale or transfer history of the subject property and comparable sales, and/or a summary of sales comparison approach. The sales comparison approach information described in this paragraph may conform to the information and language used in the Uniform Appraisal Dataset (UAD) which defines fields required for an appraisal submission for specific appraisal forms and standardizes definitions and responses for key fields.

As used herein, the subject property market area (or “subject neighborhood”) refers to the well-known name of the neighborhood in which the subject property is located and the geographical boundaries associated with the well-known neighborhood. When the property is not in a well-known neighborhood, the system uses a geographical measure to seek comps in a system defined subject market area that includes homes within a defined radius that extends from the subject property or within a defined diameter with the subject property at the center. When there is a limited number of homes within the system created subject market area, the radius or diameter may be increased until a sufficiently large number of homes to be evaluated is identified to be included in the subject property market area.

The comp appraisal system uses the comparable properties selected by the requester, as shown in block 802, if available. The comparable properties used for the comparative analysis may include those provided by the requester in the subject property data per block 802. If no comparable properties are provided by the user or if fewer than six (or other system designated number of) comparable properties are provided by the user, the comp appraisal system will proceed with the comp scoring algorithm in block 810 using the compiled comparable properties from block 800 in addition to or instead of the requester selected comparable properties. The comp scoring algorithm extracts from the comparable properties data the remaining number of comparable properties needed to conduct the comparative analysis. The comparable properties selected by the comp appraisal system to use for the comparative analysis are referred to as the “selected comparable properties.”

The comp appraisal system selects comparable properties from the comparable properties data and assigns a corresponding similarity score, as shown in block 812. The similarity score is based on one or more of, and preferably a plurality of, proximity to the subject property, gross living area, city, school system, basement type and area, design style, number of stories, number of bedrooms, number of bathrooms. The comp appraisal system then identifies one or more of the highest scoring comparable properties for the comparative analysis, as shown in block 814, to be used as part of or as the whole of the selected comparable properties. By using computing techniques, a more timely, quickly provided analysis is provided while removing human bias and subjective human errors.

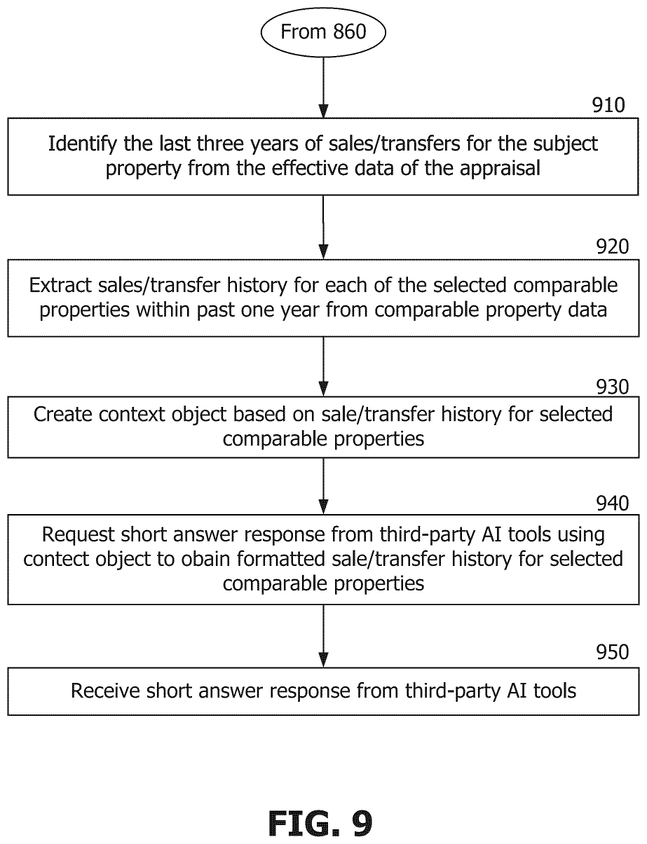

The comp appraisal system then determines comp adjustments, as shown in block 820. The comp adjustments are defined as the differences and similarities between the subject property and the selected comparable properties. The differences and similarities between the subject property and the selected comparable properties may include attributes such as, but not limited to, financial concessions, location, site, view, design style, quality of construction, actual age, condition, gross living area, number of bedrooms, number of bathrooms, basement finished area, basement area, rooms below grade, functional utility, energy efficient items, heating and cooling, garage and carport, porch/patio/deck, number of fireplaces, barns and/or additional amenities. The comp appraisal system then uses the comp adjustments to create a context object, as shown in block 830. The comp appraisal system then uses the context object to communicate a request for a short answer response to a third-party generative AI tool, as shown in block 840. This is typically done via an API provided by the third-party generative AI tool. The comp appraisal system then receives short answer responses as shown in block 850 and uses the responses to prepare the sales comparison approach section of the appraisal. For example, the third-party AI tool may be OpenAI's CHATGPT wherein the comp appraisal system provides the AI tool a prompt to return a summary of the sale comparison approach section, as shown in block 840. The short answer responses received from the third-party generative AI tool conform to commercially available appraisal forms such as but not limited to “Form 1004,” “Form 1073,” and/or “Form 1004MC.” The comp appraisal system then generates the sales/transfer history section of the appraisal, as shown in block 860, the details of which are provided in FIG. 9.

Referring now to FIG. 9, the sales/transfer history section refers to applicable sales/transfers of the subject property and the selected comparable properties. The comp appraisal system begins generating the sales/transfer history section by extracting pertinent sales/transfer information for a system defined period of time regarding the subject property data. The system defined period time used is preferably the period 3 years/36 months prior to the current day the request is made, but may be other periods of time such as 48 months, 24 months, 30 months, 18 months, 60 months, etc. The comp appraisal system analyzes the extracted sales/transfer information for the subject property to identify the last three years of applicable sales/transfers, as shown in block 910. The comp appraisal system then extracts from the comparable property data pertinent sales/transfer information for the prior one year/twelve months for example, and could also be prior 6 months, 18 months, etc., for each of the selected comparable properties, as shown in block 920. The comp appraisal system then creates a context object based on the sales/transfer information extracted for the subject property and the selected comparable properties, as shown in block 930. The comp appraisal system then uses the context object to communicate a request for a short answer response to a third-party generative AI tool, as shown in block 940. This is typically done via an API made available by the third-party generative AI tool. The comp appraisal system receives short answer responses to prepare the sales/transfer history section, as shown in block 950. For example, the third-party AI tool may be OpenAI's CHATGPT wherein the comp appraisal system provides the AI tool a prompt to return a description of the of prior sale/transfer information for the subject property and selected comparable properties, as shown in block 940. The short answer responses received from the third-party generative AI tool conform to or may be used to prepare information that conforms to commercially available appraisal forms such as but not limited to: “Form 1004,” “Form 1073,” and/or “Form 1004MC.” The comp appraisal system then uses the short answer responses to prepare the sales comparison approach section of the appraisal. By using modern computing techniques and artificial intelligence tools, a more timely, quickly provided sales comparison is provided while removing human bias and subjective human errors.

Referring again to FIG. 8, the comp appraisal system then calculates the indicated value based on the sales comparison approach, as shown in block 870. The comp appraisal system first calculates an assigned weight for each of the selected comparable properties, as shown in block 872. The assigned weight is based on the gross adjustment percentage and total gross adjustment percentage. The phrase “gross adjustment” means the total amount of adjustments applied to each comparable sale. The lower the gross adjustment percentage is, the more similar the comparable sale is to the subject property in physical characteristics. The gross adjustment is the sum of all adjustments (absolute value) made to the property. The gross adjustment will always be positive as the absolute value of each adjustment made is used in the calculation. The gross adjustment percent is the amount of the gross adjustment divided by the sale price of the home. For example, if there were $50,000 worth of adjustments made on a particular comp that sold for $1,000,000, the gross adjustment percent would be $50,000/$1,000,000, which is 0.05 or 5%.

The comp appraisal system calculates the assigned weight for each of the selected comparable properties using the following formula:

$$Assigned Weight = \frac{( 100 - ( ( \frac{Gross Adjustments \%}{Total Gross Adjustments \%} ) \times 100 ) )}{( ( Number of Comparable Properties - 1 ) \times 100 )}$$

The assigned weight is calculated by one hundred (100) less the gross adjustments percentage divided by the total gross adjustment's percentage, multiplied by one hundred (100) all divided by the number of selected comparable properties less one and multiplied by one hundred (100).

The comp appraisal system then calculates the adjusted value for each of the selected comparable properties, as shown in block 874. The adjusted value is defined as the adjusted sales price for the selected comparable property based on the adjustments determined by the comp appraisal system for each of the selected comparable properties. The adjusted value is based on the adjusted sale price for each of the selected comparable properties (“Adj. Sale Price of SCP”) and the assigned weight previously determined by the comp appraisal system. The comp appraisal system calculates the adjusted value for each of the selected comparable properties. The adjusted value is the comparable sale price minus or added value after all adjustments are applied. For example, when the comparable sale price is $250,000 and the adjusted value turns out to be $265,000, the evaluation result is that there was $15,000 of positive adjustments to the comparable sale property. The adjusted value is calculated using the following formula:

$$Adjusted Value = {\sum }_{i = 1}^{n} ( Adj . Sale Price of SCP \times Assigned Weight )$$

The adjusted value is calculated by the summation of the Adj. Sale Price of SCP multiplied by the assigned weight, where n is equal to the number of selected comparable properties. The adjusted sale price of comparable properties is calculated by adding the net adjustments to the sale price of the comparable properties. The assigned weight of the comp is calculated from the equation above. A larger weight is assigned to the property with the smallest amount of adjustments. The adjusted value of the subject property is determined by taking the sum of each comp's adjusted sale price multiplied by the assigned weight. The comp appraisal system uses the adjusted values and indicated value for the subject property based on the sales comparison approach calculated to prepare the sales comparison approach section of the appraisal.

Referring again to FIG. 2, the comp appraisal system generates one or more maps, including one or more of a location map, a flood map and an aerial view map, as shown in block 235. The location map is created based on nearby comparable sales within included in the sales comparison approach analysis. The location map includes the distance and direction of each comparable sale property in relation to the subject property. For example, a location map may include an arrow from each comparable property to the subject property overlayed on a traditional map. The flood map is a map showing the subject property and any applicable flood zone and related flood zone data. The flood map itself or flood map data needed to create a flood map may be obtained by communicating with one or more third party real property data service providers and/or a local or regional government website, database or related API. In another embodiment, the comp appraisal system refers to the additional information earlier obtained from the MLS or other third party real property data service pursuant to block 212 of FIG. 2. described above, and uses flood map data included in that additional information to create a flood map. The flood map displays a designation of whether the subject property is located in a flood zone and includes the location of the subject property, the location of the applicable flood zone or zones, a flood map number that corresponds to a government or third party map, the geographical boundaries of the flood zone, and the date of the flood map, which may be described as flood map data. Additional information such as the most recent floods and historical flood dates may be included with the flood map and flood map data. The aerial view map is an aerial view of the subject property and its immediate or nearby surroundings. In some embodiments, multiple aerial view maps may be included, one having a closer radius, such as a block or half mile, from the subject property and another having another greater radius, such as a neighborhood or 1, 2 or more miles around the subject property. The aerial map may be obtained by communicating with one or more third party aerial photography and map providers via a website, database or related API or other data communications technique.

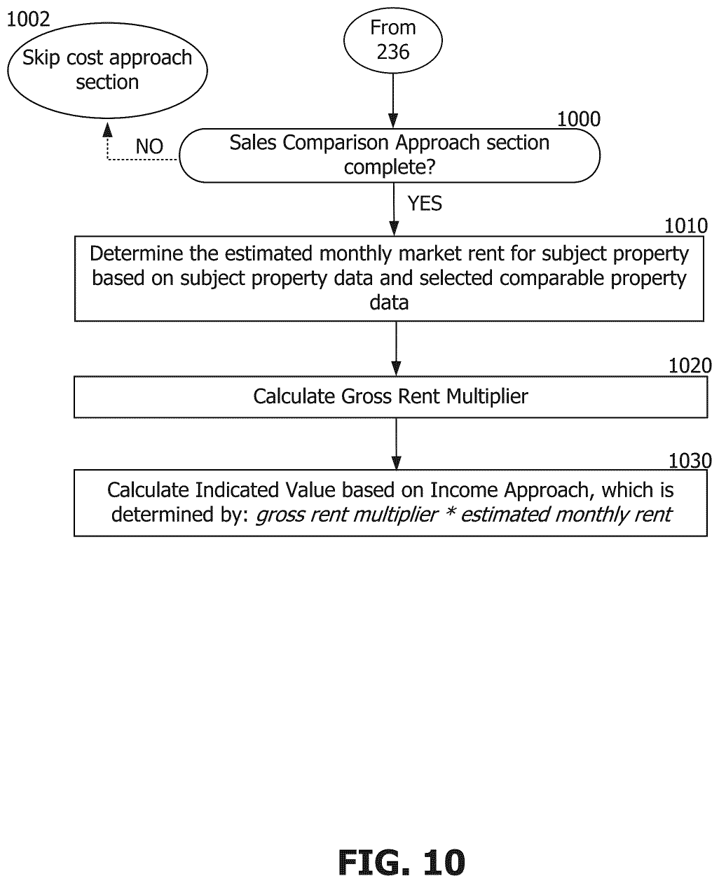

The comp appraisal system then proceeds to the income approach section to calculate the indicated value of the subject property according to the income approach as shown in block 236, for which details are provided in FIG. 10.

Referring now to FIG. 10, the comp appraisal system begins generating the income approach section by determining if the sales comparison approach section is complete, as shown in block 1000. Checking whether the sales comparison approach section is complete is necessary because the income approach section relies on the indicated value created during the preparation of the sales comparison approach. If the sales comparison approach is not complete, the comp appraisal system proceeds without the completing the income approach section, as shown in block 1002. If the income approach section is not completed, the requester is notified upon the completion of the appraisal. If the sales comparison approach section is complete, the comp appraisal system then determines the estimated monthly market rent for the subject property, as shown in block 1010. The monthly market rent is defined as the values of the most similar rentals, which may be adjusted, (that is, the rental price for comparable properties) within a system defined (or, in some embodiments, user specified) radius of the subject property. The comp appraisal system determines the monthly market rent by analyzing the comparable property data for rental prices for comparable properties within a specified radius of the subject property. The comp appraisal system may set the specified radius variably. For example, the comp appraisal system may first look for monthly market rental prices within a two mile radius, if no rental information is available, the comp appraisal will widen the radius incrementally until market rental prices for comparable properties is made available. A period of time for the rental evaluation is typically the prior 12 months, but may be expanded to 18 and 24 months, for example, to capture values and information on additional comparable rental properties.

The comp appraisal system then calculates a gross rent multiplier, as shown in block 1020. The gross rent multiplier (GRM) is a screening metric used by investors to compare rental property opportunities in a given market. The GRM functions as the ratio of a property's market value over its annual gross rental income. The GRM is based on the indicated value based on the sales comparison approach and the estimated monthly market rent. The comp appraisal system calculates the GRM using the following formula:

$$Gross Rent Multiplier = \frac{l n d i cated Value by Sales Comparison Approach}{E s t i mated Monthly Market Rent}$$

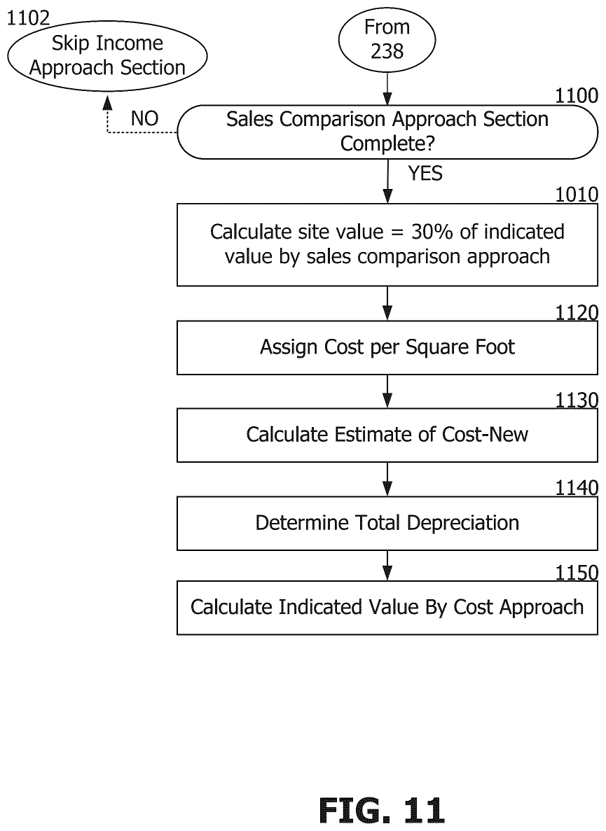

The GRM is determined by dividing the indicated value based on the sale comparison approach by the estimated monthly market rent. The comp appraisal system then calculates the indicated value of the subject property based on the income approach, as shown in block 1030. The indicated value of the subject property based on the income approach is determined by multiplying the gross rent multiplier by the estimated monthly market rent amount. The result of the income approach calculation is included in the income approach value section of the appraisal. Referring again to FIG. 2, the comp appraisal system then generates the cost approach section to calculate the indicated value based on the cost approach as shown in block 238, the details of which are provided in FIG. 11.

Referring now to FIG. 11, the comp appraisal system begins generating the cost approach section by determining if the sales comparison approach section is complete, as shown in block 1100. The checking whether the sales comparison approach section is complete is necessary because the cost approach is based in part on the indicated value determined by the sales comparison approach. If the sales comparison approach is not complete, the comp appraisal is skipped and the flow of actions proceeds without the completing the cost approach section, as shown in block 1102. If the cost approach section is not completed, the requester is notified upon the completion of the appraisal. If the sales comparison approach section is complete, the comp appraisal system then determines the site value, as shown in block 1110. The site value is defined as the estimated value of the subject property as determined by the comp appraisal system. In one embodiment, the comp appraisal system calculates the site value using the following formula:

$$Site Value = 30 \% \times Indicated Value by Sales Comparison Approach$$

The site value is calculated by multiplying the indicated value based on the sales comparison approach by 30% (thirty percent). In other embodiments, the 30% multiplier may be another value (such as, for example, 20%, 25%, 35%, etc.) depending on the implementation.

The comp appraisal system then assigns a cost per square foot, as shown in block 1120, for the dwelling area, the basement area and the garage area of the subject property. The comp appraisal system then takes the sum of each of these values to obtain the estimate of cost-new, as shown in block 1130. The cost-new is calculated using what is known as the Quantity Survey Method. The quantity survey method includes evaluating the itemized costs of erecting or installing all component parts of a new structure which includes direct and indirect costs. The indirect costs include the sum of costs for a building permit, land survey, overhead expenses, such as insurance and payroll taxes, and builder's profit. Direct costs include the sum of fees for site preparation and all phases of building construction, including fixtures. The comp appraisal system then determines the total amounts of the depreciation categories, the depreciation costs and as-is values of the improvements needed as assigned by the comp appraisal system in the improvements section for the subject property, collectively referred to as “total depreciation”, as shown in block 1140. The comp appraisal system then calculates the indicated value based on the cost approach by deducting the total depreciation from the cost-new, as shown in block 1150.

The comp appraisal system then uses the site value, cost-new, total depreciation and the indicated value for the subject property based on the cost approach to prepare the cost approach section of the appraisal. Referring back to FIG. 2, the comp appraisal system generates the reconciliation section of the appraisal, as shown in block 240.

The reconciliation section provides for the indicated value of the subject property as determined by which approach the comp appraisal system uses. The approach used hereinafter collectively refers to the indicated value based on the sales comparison approach, the indicated value based on the income approach and the indicated value based on the cost approach. The requester may specify one or more of the approaches as deemed appropriate. If the requester does not specify an approach, the comp appraisal system will proceed with all three approaches. The comp appraisal system begins generating the reconciliation section by determining a final indicated value for the subject property based on the indicated values determined by the approaches used. Based on the criteria selected by a requester, the comp appraisal system then determines if the appraisal is made “as is”, subject to completion per plans and specifications on the basis of a hypothetical condition that the improvements have been completed, subject to the following repairs or alterations on the basis of a hypothetical condition that the repairs or alterations have been completed, or subject to an inspection based on the extraordinary assumption that the condition or deficiency does not require alteration or repair, collectively referred to as the “appraisal type determination”. The determination conforms to commercially available appraisal forms such as but not limited to: “Form 1004,” “Form 1073,” and/or “Form 1004MC.” The comp appraisal system uses the indicated value based on the approaches used, the appraisal type determination and the final indicated value to prepare the reconciliation section. The comp appraisal system then generates the market conditions section of the appraisal, as shown in block 242.

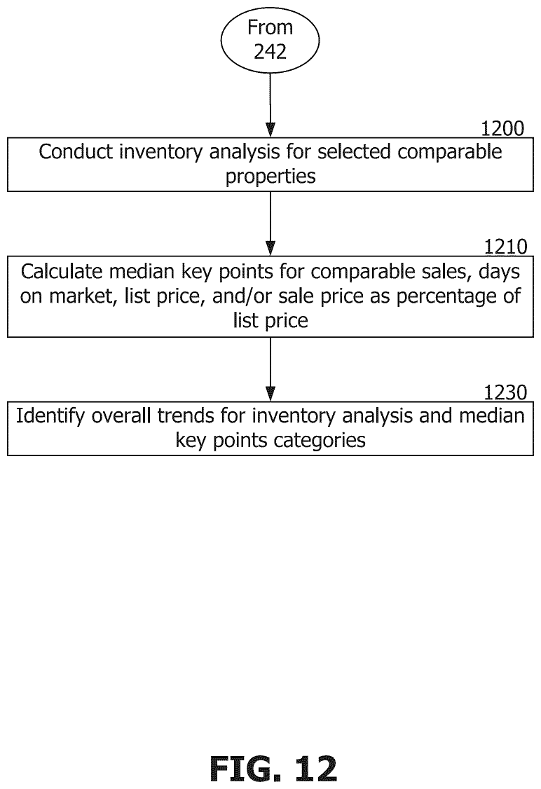

The market conditions section is prepared in accordance with the “Market Conditions Addendum to the Appraisal Report,” Fannie Mae Form 1004MC as is commercially used with the real estate appraisal industry. Referring now to FIG. 12, the comp appraisal system begins generating the market conditions section by conducting an inventory analysis based on the comparable property data, as shown in block 1200. The inventory analysis includes extracting from the comparable property data information such as but not limited to, the total number of settled comparable sales, the absorption rate determined by the total sales divided by the total number of months on sale, total number of comparable active listings, months of housing supply determined by the total listings divided by the absorption rate. The comp appraisal system then calculates median key points, as shown in block 1210. The comp appraisal system determines the median key points by analyzing the data obtained from the inventory the median comparable sale price, the median comparable sales days on market, the median comparable list price, the median comparable listings days on market, and median sale price as percentage of list price. The inventory analysis and median key points are determined for time periods of, the prior seven months to twelve months, the prior four months to six months, and current date to the estimated next three months. The comp appraisal system then identifies overall trends for each of the time periods for the inventory analysis and median key points categories, as shown in block 1230. The overall trends for both the inventory analysis and median key points are one of: increasing, stable, or decreasing. An increasing overall trend refers to rising growth in the respective category. A decreasing overall trend refers to falling growth in the respective category. A stable overall trend refers to a fixed growth in the respective category. The comp appraisal system then uses the inventory analysis, median key points and determined overall trends to prepare the market conditions section of the appraisal. The comp appraisal system then generates the text addendum section of the appraisal, as shown in block 244.

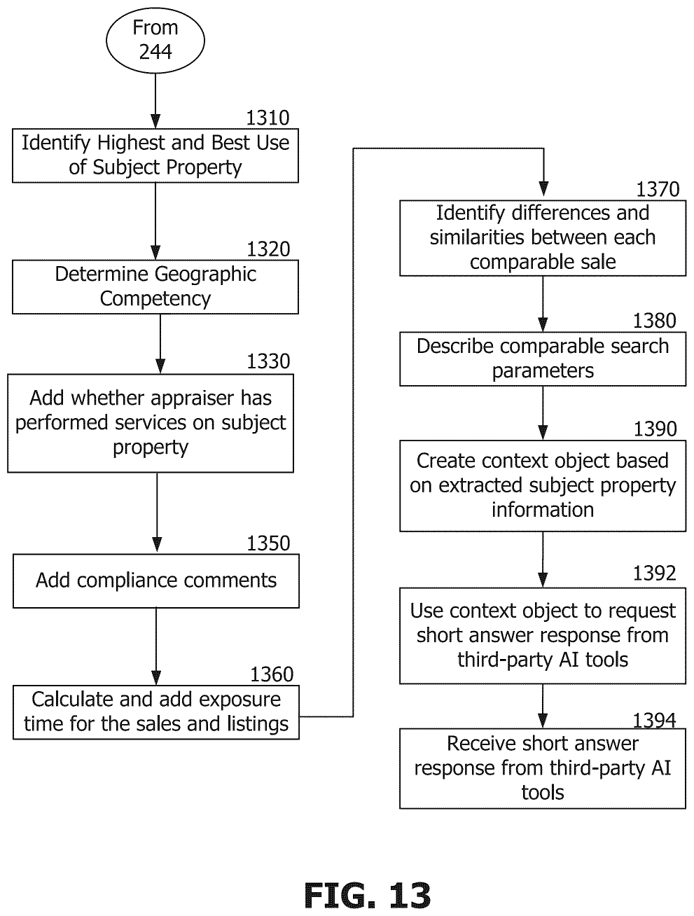

The text addendum section is used to explain the methods used by the comp appraisal system to generate the appraisal report. Referring now to FIG. 13, the comp appraisal system begins generating the text addendum section by identifying the highest indicated value and best use of the subject property, as shown in block 1310. The text addendum is an additional page of the appraisal report that explains in layman's terms the strategies used reach the conclusions made in the report as well as any special or unique information pertinent to the appraisal analysis. The text addendum may include, for example, without limitation, a summary of the search parameters used in the sales comparison approach, brief descriptions of unusual comps or adjustments, whether the subject property is being using for its highest and best use, etc. The highest and best use includes four tests an appraiser conducts on the property. The four tests evaluate: legal permissibility, physical possibility, financial feasibility, and maximum productivity. The subject property must pass all four tests.

The comp appraisal system then prepares the geographic competency section, as shown in block 1320. The term geographic competency reflects whether the appraiser has the sufficient knowledge of the subject property market area to provide a credible appraisal report. To be geographically competent means the appraiser has the skills and resources necessary to competently complete the assignment pursuant to the Uniform Standard of Professional Appraisal Practice (USPAP). The comp appraisal system then states whether the appraiser/comp appraisal system has conducted services regarding the subject property within a period of time such, for example, the last one, two, three years, as shown in block 1330. The comp appraisal system then generates and adds compliance comments as shown in block 1350. The compliance comments are notes about the appraiser, such as additional information about the training and experience of the appraiser.

The comp appraisal system generates and adds exposure time comments for the sales and listings, as shown in block 1360. As used herein, exposure time is the estimated length of time the property being appraised would have been offered on the market prior to the hypothetical consummation of a sale at market value on the effective date of the appraisal. The comp appraisal system identifies similarities between each of the comparable properties sales, as shown in block 1370, and describes comparable search parameters used by the comp appraisal system as shown in block 1380.

The comp appraisal system uses the information it prepared for the text addendum section in blocks 1310-1380 to generate the text addendum section using third party AI tools. Specifically, the comp appraisal system uses the information it generates for the text addendum section, as shown in blocks 1310-1380 (collectively referred to as the “text addendum details”) to create a context object, as shown in block 1390. The comp appraisal system then uses the context object to communicate a request for a short answer response to one or more third-party generative AI tools, as shown in block 1392. This is typically done via an API of the third-party AI tools. The comp appraisal system receives the short answer responses, as shown in block 1394. For example, the third-party AI tool may be OpenAI's CHATGPT, wherein the comp appraisal system provides the AI tool a request to return natural language sentences for the compliance comments, exposure time comments, differences and similarities of the comparable properties sales information, comparable properties search parameters, and geographic competencies to create a natural language response inclusive of these details. The short answer responses received from the third-party generative AI tool conform to commercially available appraisal form such as but not limited to: “Form 1004,” “Form 1073,” and/or “Form 1004MC.” The comp appraisal system then uses the text addendum details and short answer responses to prepare the text addendum section of the appraisal.

Referring again to FIG. 2, the comp appraisal system then generates the appraisal report and provides the appraisal report to the requester, as shown in block 250. The comp appraisal system populates real estate appraisal forms with subject property data and details generated from the subject section, the contract section, the neighborhood section, the site section, the improvements section, the income approach section, the sales comparison approach section, the reconciliation section, the sales/transfer history section, the cost approach section, the market conditions section, the text addendum section, and the final indicated value (collectively the “subject property dataset”). The comp appraisal system may provide the subject property dataset to a requester through computing devices either as a downloadable file or displayed on a related user interface. The downloadable file may be but is not limited to a tabulated report such as in a MISMO Data XML file, populated onto a PDF, ENV, text or other format document. The comp appraisal system may also use the subject property dataset to populate forms such as but not limited to: “Form 1004,” “Form 1073,” and/or “Form 1004MC.”

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method for objectively providing a listing of comparable real estate properties, the method performed by a software application executing on at least one server having a processor and memory, the method comprising:
receiving over a network an appraisal request, the appraisal request including a subject property data set, the subject property data set including a subject property address, at least one subject property photograph, and at least one of a purchase agreement and/or an engagement letter;
accessing a multiple listing service (MLS) database to obtain a comparable property data set using the subject property address as a search criteria, the comparable property data set comprising a plurality of comparable property addresses, a plurality of comparable property photographs, and a plurality of sales reports for a plurality of comparable properties;
querying a first third party generative AI tool with some of the comparable property data set to obtain additional details for the subject property data set;
evaluating the subject property data set with the comparable property data set, including using AI image recognition software to compare photographs from the subject property dataset and the comparable property data set;
assigning an indicated value;
generating an appraisal report including the subject property data set, the comparable property data set and the indicated value, including accessing a second third party generative AI tool to assist in formatting some of the data included in the appraisal report according to well-known standards;
providing the appraisal report to the requester via the network.

2. The method of claim 1 wherein the subject property data set further comprises at least one comparable property address.

3. The method of claim 1, wherein the comparable property data set comprises at least one selected from the group including: property square footage, number of bedrooms, number of bathrooms, city, state, zip code, subject property images, home type, property title type, design, property age, basement and finishings, utilities, heating/cooling garage/carport, porch/patio/deck, sales price, neighborhood descriptions, proximity to schools/municipalities.

4. The method of claim 1, wherein the subject property data set comprises at least one selected from the group including: property square footage, number of bedrooms, number of bathrooms, city, state, zip code, subject property images, home type, property title type, design, property age, basement and finishings, utilities, heating/cooling garage/carport, porch/patio/deck, sales price, neighborhood descriptions, proximity to schools/municipalities.

5. The method of claim 1, wherein the AI image recognition software detects and labels at least one selected from the group including: appliances, materials, room types, condition and quality of construction, deferred maintenance, evidence of water infiltration, unidentified black substance, evidence of deterioration, and infestation for each of the subject property data set and respective comparable property data set.

6. The method of claim 1, wherein the indicated value is determined using at least one of a sales comparison approach, an income approach, and/or a cost approach.

7. The method of claim 6, wherein the sales comparison approach is determined by a weight calculated from the second data set gross adjustment percentages and the number of the at least one comparable property used as represented by the formula:
$$Weight = \frac{( 100 - ( ( \frac{Gross Adjustments \%}{Total Gross Adjustments \%} ) \times 100 ) )}{( ( Number of Comparable Properties - 1 ) \times 100 )}$$
wherein the indicated value is then calculated by the summation of the adjusted sales price of the at least one comparable property multiplied by the weight as represented by the formula:
$$Indicated Value = {\sum }_{i = 1}^{n} ( Adjusted Sale Price of Comparable Properties \times Weight ) .$$

8. The method of claim 6, wherein the sales comparison approach evaluates information provided according to the Uniform Appraisal Dataset (UAD) standard.

9. The method of claim 6, wherein the income approach is determined using a gross rent multiplier multiplied by an estimated monthly market rent amount.

10. The method of claim 9, wherein the gross rent multiplier is calculated by dividing the indicated value based on the sales comparison approach by the estimated monthly market rent.

11. The method of claim 9, wherein the estimated monthly market rent amount is determined from the comparable data set.

12. The method of claim 6, wherein the cost approach is calculated by taking thirty percent of the indicated value computed using the sales comparison approach.

13. The method of claim 1, wherein the appraisal report is a downloadable formatted electronic file

14. The method of claim 1, wherein the appraisal report is displayed on a graphical user interface on the network connected computing device.

15. A storage medium having instructions stored thereon which when executed by a processor cause the processor to perform operations to generate an appraisal report comprising:
sending a first property data set, the first property data set comprising a first property address, at least one first property photograph, and a purchase agreement and/or an engagement letter;
creating a second property data set, the second property data set comprising an at least one comparable property address, at least one comparable property photograph, and a sales report, wherein the at least one comparable property address being within a radius of the first property address;
utilizing third-party artificial intelligence software to compare the first property data set with the second property data set;
assigning an appraisal value for the first property data set;
and generating an appraisal report.

16. The storage medium of claim 15, wherein the wherein the first property data set and second property data set each comprise data reflecting property square footage, number of bedrooms, number of bathrooms, city, state, zip code, subject property images, home type, property title type, design, property age, basement and finishings, utilities, heating/cooling, garage/carport, porch/patio/deck, sales price, neighborhood descriptions, proximity to schools/municipalities.

17. The storage medium of claim 15, wherein the third-party artificial intelligence software includes image recognition functionality to detect and label appliances, materials, room types, condition and quality of construction for the first property data set and the second property data set.

18. The storage medium of claim 15, wherein the appraisal value is based on at least one of an appraisal value based a sales comparison approach, an appraisal value based an income approach, and/or an appraisal value based a cost approach.

19. The storage medium of claim 15, wherein the appraisal value based on the sales comparison approach is determined using a weight calculation based on the second data set gross adjustment percentages and the number of the at least one comparable property used as represented by the formula:
$$Weight = \frac{( 100 - ( ( \frac{Gross Adjustments \%}{Total Gross Adjustments \%} ) \times 100 ) )}{( ( Number of Comparable Properties - 1 ) \times 100 )}$$
wherein the appraisal value is then calculated by the summation of the adjusted sales price of the at least one comparable property multiplied by the weight as represented by the formula:
$$I ndicated Value = {{\sum }_{i = 1}}^{n} ( Adjusted Sale Price of Comparable Properties \times Weight ) .$$

20. The storage medium of claim 15, wherein the appraisal value is based on an income approach determined by a gross rent multiplier multiplied by an estimated monthly market rent amount, wherein the gross rent multiplier is calculated by dividing the appraisal value based on the sales comparison approach by the estimated monthly market rent, and the estimated monthly market rent amount is determined by accessing the third party artificial intelligence software.

21. The storage medium of claim 15, wherein the cost approach is calculated by taking thirty percent of the appraisal value based on the sales comparison approach.
